(19) United States
(12) Patent Application Publication
(10) Pub. No.: US 2021/0062859 A1
(43) Pub. Date: Mar. 4, 2021

(54) Universal Connector

(71) Applicant: Xuejun Chen, Jinhua City (CN)

(72) Inventor: Xuejun Chen, Jinhua City (CN)

(21) Appl. No.: 16/998,099

(22) Filed: Aug. 20, 2020

(30) Foreign Application Priority Data
Aug. 30, 2019 (CN) 201921438815.2

(51) Int. Cl. F16B 47/00; F16M 13/02; F16C 11/04

(52) U.S. Cl. CPC F16B 47/00; F16G 11/143; F16C 11/04; F16M 13/02

(57) ABSTRACT

A universal connector contains: a lock seat and a U-shaped rotation element. The lock seat is mounted on a sucker, and a T-shaped rivet is configured to rotatably connect the lock seat and the U-shaped rotation element. The U-shaped rotation element has a U-shaped opening opposite to the lock seat, two orifices defined on two extensions of two sides of the U-shaped rotation element, and a first cap screw bolt accommodated in the two orifices and fixed perpendicular to the T-shaped rivet. In addition, the sucker includes a pump configured to pump airs out of the sucker.

### FIELD OF THE INVENTION

The present invention relates to a universal connector which is configured to connect with an object (such as a puller or a hook) so that the object is rotated by the universal connector universally.

### BACKGROUND OF THE INVENTION

A conventional connector cannot be fixed with an object on a smooth wall or surface securely.

The present invention has arisen to mitigate and/or obviate the afore-described disadvantages.

### SUMMARY OF THE INVENTION

One aspect of the present invention is to provide a universal connector which is configured to connect with an object (such as a puller or a hook) so that the object is rotated by the universal connector universally.

To obtain the above aspects, universal connector provided by the present invention contains: a lock seat and a U-shaped rotation element.

The lock seat is mounted on a sucker, and a T-shaped rivet is configured to rotatably connect the lock seat and the U-shaped rotation element. The U-shaped rotation element has a U-shaped opening opposite to the lock seat, two orifices defined on two extension of two sides of the U-shaped rotation element, and a first cap screw bolt accommodated in the two orifices and fixed perpendicular to the T-shaped rivet. The sucker includes a pump configured to pump airs out of the sucker.

Preferably, the lock seat is disposed on the sucker by way of four second cap screw bolts.

Preferably, a bearing is defined between the U-shaped rotation element and the lock seat, and the T-shaped rivet is connected on the sucker via the bearing and a washer which is defined between the lock seat and the sucker.

Preferably, the first cap screw bolt is screwed with a third cap screw bolt via the two orifices of the two extensions of the U-shaped rotation element.

Preferably, the pump is fixed between the lock seat and the sucker.

### BRIEF DESCRIPTION OF THE DRAWINGS

FIG. 1 is a perspective view showing the exploded components of a universal connector according to a preferred embodiment of the present invention.

### DETAILED DESCRIPTION OF THE PREFERRED EMBODIMENTS

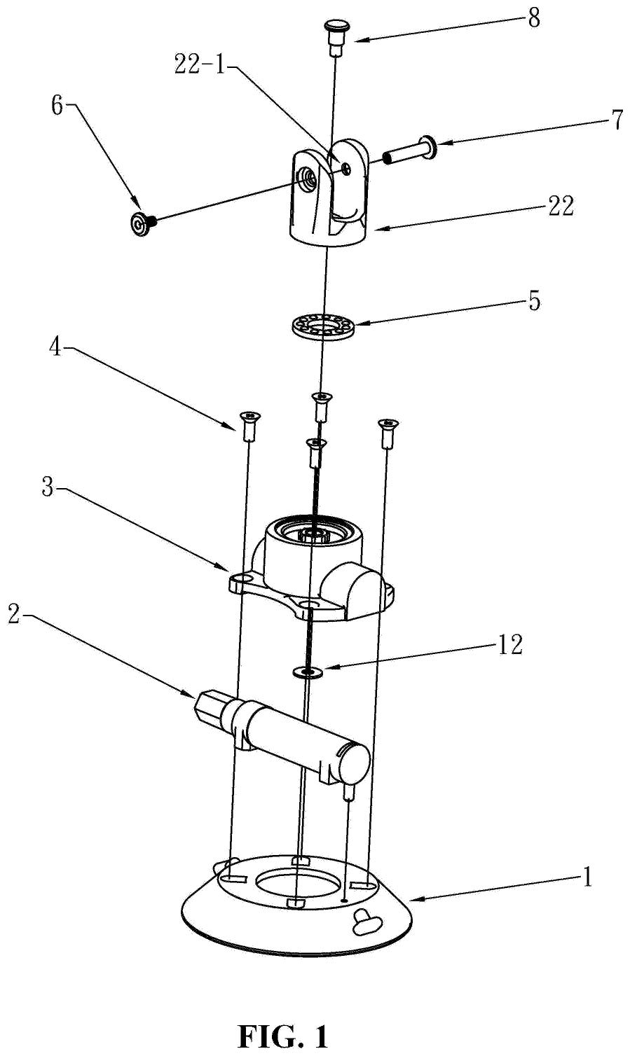

With reference to FIG. 1, a Universal connector according to a preferred embodiment of the present invention comprises: a lock seat 3 and a U-shaped rotation element 22, wherein the lock seat 3 is mounted on a sucker 1, and a T-shaped rivet 8 is configured to rotatably connect the lock seat 3 and the U-shaped rotation element 22, wherein the U-shaped rotation element 22 has a U-shaped opening opposite to the lock seat 3, two orifices 22-1 defined on two extension of two sides of the U-shaped rotation element 22, a first cap screw bolt 7 accommodated in the two orifices 22-1 and fixed perpendicular to the T-shaped rivet 8, and the sucker 1 includes a pump 2 configured to pump airs out of the sucker 1.

The lock seat 3 is disposed on the sucker 1 by way of four second cap screw bolts 4.

A bearing 5 is defined between the U-shaped rotation element 22 and the lock seat 3, and the T-shaped rivet 8 is connected on the sucker 1 via the bearing 5 and a washer 12 which is defined between the lock seat 3 and the sucker 1.

The first cap screw bolt 7 is screwed with a third cap screw bolt 6 via the two orifices 22-1 of the two extensions of the U-shaped rotation element 22.

The pump 2 is fixed between the lock seat 3 and the sucker 1.

In application, as shown in FIG. 1, the universal connector is configured to fix a puller on a smooth wall.

For example, the sucker 1 is fixed on the smooth wall, and the pump 2 pumps the airs out of the sucker 1 completely so that the sucker 1 attaches on the smooth wall securely.

A shell of the puller is rotatably connected with the first cap screw bolt 7, the puller is rotated along the first cap screw 7, and the U-shaped rotation element 22 rotates along the T-shaped rivet 8, wherein the T-shaped rivet 8 is perpendicular to the first cap screw 7, thus rotating the puller universally.

Preferably, the universal connector is connected with other components on a smooth surface, for example, rotating a hook on the first cap screw 7, thus operating the hook universally.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A universal connector comprising:
a lock seat and a U-shaped rotation element, wherein the lock seat is mounted on a sucker, and a T-shaped rivet is configured to rotatably connect the lock seat and the U-shaped rotation element, wherein the U-shaped rotation element has a U-shaped opening opposite to the lock seat, two orifices defined on two extension of two sides of the U-shaped rotation element, and a first cap screw bolt accommodated in the two orifices and fixed perpendicular to the T-shaped rivet, wherein the sucker includes a pump configured to pump airs out of the sucker.

2. The universal connector as claimed in claim 1, wherein the lock seat is disposed on the sucker by way of four second cap screw bolts.

3. The universal connector as claimed in claim 1, wherein a bearing is defined between the U-shaped rotation element and the lock seat, and the T-shaped rivet is connected on the sucker via the bearing and a washer which is defined between the lock seat and the sucker.

4. The universal connector as claimed in claim 2, wherein a bearing is defined between the U-shaped rotation element and the lock seat, and the T-shaped rivet is connected on the sucker via the bearing and a washer which is defined between the lock seat and the sucker.

5. The universal connector as claimed in claim 3, wherein the first cap screw bolt is screwed with a third cap screw bolt via the two orifices of the two extensions of the U-shaped rotation element.

6. The universal connector as claimed in claim 5, wherein the pump is fixed between the lock seat and the sucker.
